(19) United States
(12) Patent Application Publication
(10) Pub. No.: US 2015/0188312 A1
(43) Pub. Date: Jul. 2, 2015

(54) ELECTROSTATIC DISCHARGE PROTECTION

(71) Applicant: Cambridge Silicon Radio Limited, Cambridge (GB)

(72) Inventor: Terence Chi-Fung Kwok, London (GB)

(73) Assignee: Cambridge Silicon Radio Limited, Cambridge (GB)

(21) Appl. No.: 14/141,861

(22) Filed: Dec. 27, 2013

(51) Int. Cl. H02H 9/04; H05F 3/00

(52) U.S. Cl. CPC H02H 9/044; H05F 3/00; H02H 9/04

(57) ABSTRACT

An integrated circuit chip including: a chip pin configured to direct signals on and off chip; a first signal path from the chip pin to a first electrostatic discharge (ESD) susceptible circuit susceptible to a voltage greater than a first voltage level; a first protection circuit coupled to a first node on the first signal path, the first protection circuit being operable to limit the voltage of a signal directed on chip to a second voltage level, the second voltage level being higher than the first voltage level; and a second protection circuit coupled to a second node on the first signal path between the first node and the first ESD susceptible circuit, the second protection circuit being operable to limit the voltage of the signal directed on chip to the first voltage level.

This invention relates to an integrated circuit (IC) chip which protects parts of the integrated circuit that are susceptible to being damaged by an electrostatic discharge (ESD) or other sources of potentially damaging voltages.

### BACKGROUND

An ESD can damage devices in an IC due the high voltage of the ESD signal. Typically, ESD voltages can be as high as around 1 kV. As the feature size of devices become smaller, the devices become more susceptible to being damaged at lower voltages. In some cases, voltages as low as 1V can cause a device to be permanently damaged.

In order to protect an IC chip from a potentially damaging voltages, e.g. from ESD, it is commonplace to provide an ESD clamp between a node on the IC and ground. During an ESD event, an ESD clamp provides a safe current path through the chip and around the circuit being protected. When an ESD events occurs, the ESD clamp acts to conduct the electrostatic charge to ground, thus dissipating the potentially damaging high voltage. These ESD clamps are configured to trigger when an ESD event is detected and then subsequently limit the voltage to below the lowest failure voltage of all the components in the circuit. However, such ESD clamps require the circuit to be powered so the ESD event can be detected and the clamp triggered. Thus an ESD event occurring when the IC is not powered, e.g. during manufacturing, can still lead to the IC to be damaged.

There is therefore a need for a circuit arrangement that can protect voltage-sensitive parts or components from sources of potentially damaging voltages, e.g. during an ESD event, when the circuit is not powered.

### SUMMARY OF INVENTION

According to a first aspect of the disclosure, there is provided an integrated circuit chip comprising: a chip pin configured to direct signals on and off chip; a first signal path from the chip pin to a first electrostatic discharge (ESD) susceptible circuit susceptible to a voltage greater than a first voltage level; a first protection circuit coupled to a first node on the first signal path, the first protection circuit being operable to limit the voltage of a signal directed on chip to a second voltage level, the second voltage level being higher than the first voltage level; and a second protection circuit coupled to a second node on the first signal path between the first node and the first ESD susceptible circuit, the second protection circuit being operable to limit the voltage of the signal directed on chip to the first voltage level.

Suitably, the second protection circuit is susceptible to a voltage greater than a third voltage level, the second voltage level being lower than the third voltage level.

Suitably, the second protection circuit is susceptible to a voltage greater than a third voltage level, the integrated circuit chip further comprises a passive component coupled between the first node and the second node, the passive component having a resistance so as to limit the voltage of the signal directed on chip to below the third voltage level.

Suitably, the passive component is configured to, when the integrated circuit chip receives a radio frequency signal, cause that received radio frequency signal to have a higher voltage on input to the first ESD susceptible circuit than when at the chip pin.

Suitably, the chip further comprises a second ESD susceptible circuit susceptible to a voltage greater than the second voltage level and coupled to a third node on the first signal path between the first node and the second node.

Suitably, the second ESD susceptible circuit is coupled to the third node so as to provide a second signal path from the chip pin to the second ESD susceptible circuit, the integrated circuit chip further comprising a switch coupling the first signal path between the third node and the first ESD susceptible circuit to ground and operable so as to isolate the first protection circuit from the second signal path.

Suitably, the first ESD susceptible circuit comprises a low noise amplifier for amplifying received radio frequency signals and the second ESD susceptible circuit comprising a power amplifier for amplifying radio frequency signals for transmission.

Suitably, the radio frequency signals are in accordance with a Bluetooth protocol.

Suitably, the first protection circuit comprises a gate grounded transistor and the second protection circuit comprises a diode, and wherein the second protection circuit does not comprise a gate grounded transistor.

According to a second aspect of the disclosure, there is provided a method comprising: manufacturing an integrated circuit chip according to the first aspect above; disabling the first and/or second protection circuit; and packaging the integrated circuit chip.

### BRIEF DESCRIPTION OF THE DRAWINGS

The present invention will now be described by way of example with reference to the accompanying drawings, in which:

FIG. 1 illustrates exemplary receiver circuitry;

FIG. 2 illustrates exemplary transceiver circuitry;

FIG. 3A illustrates an exemplary arrangement of the first protection circuit of FIGS. 1 and 2; and

FIG. 3B illustrates an exemplary arrangement of the second protection circuit of FIGS. 1 and 2.

### DETAILED DESCRIPTION

The following description is presented to enable any person skilled in the art to make and use the invention, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Embodiments of the present invention provide improved protection from potentially damaging voltages (e.g. from ESD events) for susceptible circuit components while minimising the cost (e.g. minimising stray capacitance, chip area, etc) of providing that protection. In the examples below, protection for circuitry for receiving and/or transmitting radio frequency (rf) signals is described. However, the protection described can be applied to other types devices or circuits that are sensitive to high voltages, e.g. from ESD events.

Integrated circuit chips can be used to transmit and receive wireless communications. Traditionally, the transmit circuitry is separate from the receive circuitry on an integrated circuit chip. Two antennas are utilised: one for receiving rf signals, and one for transmitting rf signals. The transmit and receive signal paths from the antennas to the baseband processing are entirely separate.

Market demand for ever smaller communications products has resulted in this traditional approach being modified with the goal of reducing the area of the product dedicated to the transceiver circuitry. A common approach to reduce the product area is to utilise the same antenna for transmitting and receiving rf signals. Generally the antenna is off-chip. The same chip pin is utilised to both (i) direct signals to be transmitted from the transmit circuitry to the antenna, and (ii) direct signals received by the antenna to the receive circuitry.

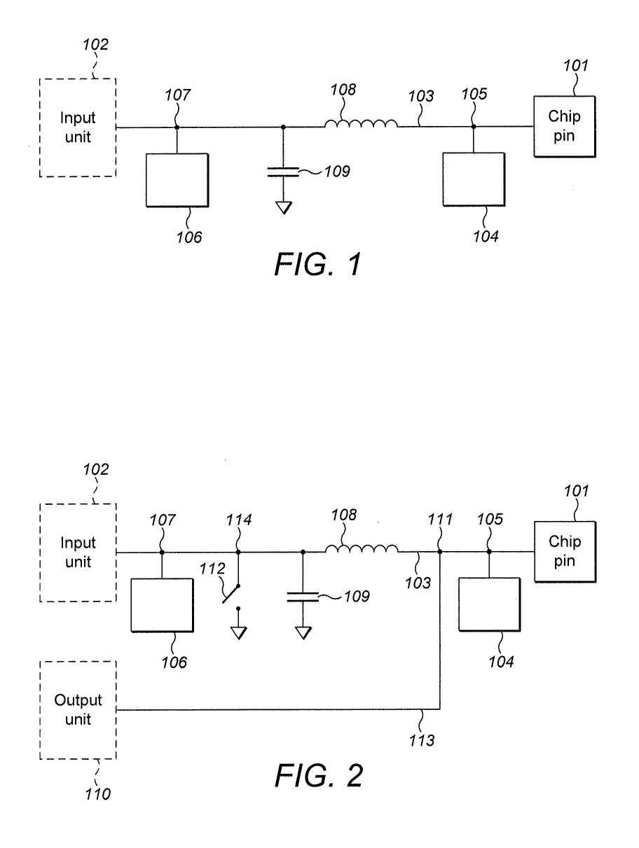

FIG. 1 illustrates a general structure of exemplary circuitry for receiving an rf signal at a chip pin 101. An input unit 102 is coupled to the chip pin 101 via a signal path 103. The input unit 102 may comprise one or more electronic components that are susceptible to being damaged when a voltage above an associated tolerance level is applied at the input unit 102.

In an ESD context, a component in an integrated circuit may be considered to be tolerant of a voltage across it if the component can support that voltage for the typical length of an ESD event. The maximum voltage a component is tolerant of is the voltage above which it will become irreversibly damaged if that voltage is applied for a non-period (the length of an ESD event). A rough indication of the voltage to which a component is tolerant to may be given by the maximum rated voltage of a component or circuit.

The input unit 102 is tolerant up to a first voltage level. If a voltage above the first voltage level is applied to the input unit 102 (e.g. during an ESD event) then it will be susceptible to being damaged.

In an example embodiment, the input unit 102 may include receive circuitry which may include a low noise amplifier and automatic gain control that are susceptible to an ESD event. The receive circuitry may be implemented in a low power transceiver and may be susceptible to voltages greater than 0.6V.

A first protection circuit 104 is coupled to a node 105 on the signal path 103. The protection circuit 104 is configured to limit (or “clip”) the voltage of signals (e.g. from ESD events) that are directed onto the chip via the chip pin 101 to a second voltage level. The signals can have a positive or negative voltage and can propagate along the signal path 103. The protection circuit 104 limits the positive and/or negative voltage to the magnitude of the second voltage level depending on the configuration of the circuit 104. For example, the circuit 104 can be configured to limit the voltage of a signal to ±6V depending on the polarity of the signal directed onto the chip. The limited (or “clipped”) signal is applied to the rest of the circuitry.

The second voltage level to which the first protection circuit 104 limits signals to is higher than the first voltage level that the input unit 102 is susceptible to. Thus, the limited signal may still damage the input unit 102.

A second protection circuit 106 is coupled to node 107 on the signal path 103 between node 105 and input unit 102. The second protection circuit 106 is configured to limit the voltage of a signal to the first voltage level. Thus a signal limited to the second voltage level by the first protection circuit 104 can be further limited by the second protection circuit 106 to the first voltage level so that adequate protection can be applied to the input unit 102. For example, when a signal such as an ESD signal is applied the chip pin 101, the first protection circuit 104 limits the ESD signal to ±6V. The second protection circuit 106 then further limits the ±6V signal to a lower voltage, e.g., ±0.6V, that is tolerable to the input unit 102. Thus, together, the first and second protection circuits 104 and 106 can provide the required amount of protection to adequately protect the input unit 102 during an ESD event.

The second protection circuit 106 itself may also only be able to tolerate voltages up to a third voltage level. Voltages above the third voltage level may cause the second protection circuit 106 to be damaged. Thus, preferably, the second voltage level that the first protection circuit 104 limits to is lower than the third voltage level. Thus, a signal directed on chip via the chip pin 101 that has a voltage that would not be tolerable to the second protection circuit 106 is limited by the first protection circuit 104 to prevent the second protection circuit 106 from being damaged.

The circuitry for receiving an rf signal may comprise a filter that is coupled to the signal path 103. The filter may comprise a resonant circuit. This resonant circuit can comprise an inductor 108 and a capacitor 109. The inductor 108 is coupled to the signal path 103 between node 105 and node 107 (i.e. between the coupling points of the first and second protection circuits 104 and 106). The inductor 108 is connected in series on the first signal path 103. Preferably, the capacitor 109 is a variable capacitor which can tune the resonant frequency of the resonant circuit to the desired frequency of an rf signal received at the chip pin 101. When the resonant circuit is tuned to resonate at the frequency of the received rf signal, the resonant circuit provides a passive voltage gain to the received rf signal, which is useful to the input circuit 102.

The inductor 108 has a series resistance which acts to reduce the voltage of signals that are not at the resonant frequency. Thus the inductor 108 can reduce the voltage of signals such as an ESD signal as the frequency of the ESD signal will not be at the same frequency as the resonant frequency of the resonant circuit. Thus the voltage of the ESD signal limited by the first protection circuit 104 can be reduced further by the inductor 108. This can allow the second voltage level limited by the first protection circuit 104 to be higher as the inductor 108 can reduce the voltage of a signal applied at the second protection circuit 106. Thus the first protection circuit 104 may limit the voltage of a signal to a voltage that is higher than the tolerable voltage of the second protection circuit (i.e. the second voltage level being greater than the third voltage level) and then the inductor 108 can further reduce that limited signal to a level that tolerable to second protection circuit 106 (i.e. reduced to a level below the third voltage level).

The level of resistance provided by the inductor 108 may be dependent on the rise time of the signal applied at the inductor. For example, an ESD signal, such as a pulse according to the human body model (HBM), may have a rise time that is sufficiently slow that the effective resistance of the inductor 108 is the metal resistance of the windings. For a pulse according to the charged device model (CDM), the rise time may be shorter which can cause the inductor 108 to reduce the peak voltage experienced in the core to a greater extent than for the HBM pulse. For example, the inductor 108 may reduce a CDM pulse by a few volts in dependence on the inductance of the inductor 108.

There is a cost associated with providing protection circuits on chip. The ESD protection circuits use up valuable chip area, introduce unwanted effects like stray capacitance, increase manufacturing expense, etc. Generally, the higher the tolerance of the core components to voltage spikes during an ESD event, the larger in area, and thereby the more expensive, the on-chip ESD protection components become. Thus, it is advantageous to minimise the amount of the voltage that an ESD protection circuit is required to limit. Therefore, by providing the inductor 108, the amount of voltage limiting required by the first protection circuit 104 is reduced and so is its associated cost. Furthermore, as discussed further below, a second protection circuit 106 with a lower tolerance voltage (i.e. the third voltage level) can be provided as the inductor reduces the voltage of a signal applied at the second protection circuit 106. Thus the cost associated with the second protection circuit 106 is also reduced.

FIG. 2 illustrates the general structure of exemplary circuitry for transmitting and receiving an rf signal at a chip pin 101. The rf receive path in the embodiment of FIG. 2 comprises the chip pin 101, input unit 102, signal path 103, first and second protection circuits 104 and 106 and nodes 105 and 107 and their arrangement as described above in relation to FIG. 1. Optionally, the receive path may also comprise the inductor 108 and capacitor 109 as described above.

An output unit 110 may be coupled to node 111 located on the signal path 103 between nodes 105 and 107. In an embodiment including the inductor 108 in the receive path, node 111 is located between node 105 and inductor 108. The path between the chip pin 101 and the output unit 110, via node 111 provides a transmit path 113 suitable for rf signals that are to be transmitted. For example, the output unit 110 can include transmit circuitry which may include a power amplifier. However, the transmit path also provides a pathway for potentially damaging voltages directed onto the chip pin 101 to be directed to the output unit 110.

The output unit 110 may comprise one or more electronic components that are susceptible to being damaged when a voltage above an associated tolerance level is applied at the output unit 110. Preferably, the output unit 110 is tolerant up to the second voltage level. If a voltage above the second voltage level is applied to the output unit 110 (e.g. during an ESD event) then it will be susceptible to being damaged. Node 111 is located after the first protection circuit 104 on the signal path 103 and so the first protection circuit 104 can limit the voltage of a signal to the second voltage level and a tolerable voltage can be provided at the output unit 110.

The output unit 110 may have a lower voltage sensitivity than the input unit 102. In other words, the output unit 110 may be able to tolerate higher voltages than the input unit 102. For example, the input unit 102 may be susceptible to damage at voltages greater than ±0.6V, whereas the output unit 110 may be susceptible to damage at voltages greater than ±6V. Thus the input unit 102 is more susceptible to being damaged than the output unit 110 and therefore requires a greater level of protection.

As mentioned above, the ESD protection circuits introduce unwanted effects like stray capacitances. Thus, preferably, a switch 112 is coupled to the receive path so that the output unit 110 can be isolated from the second ESD protection circuit 106 when the chip is transmitting an RF signal. The switch 112 is coupled to a node 114 on the receive path between nodes 107 and 111. In an embodiment including the filter comprising the inductor 108 and capacitor 109, node 114 is preferably between node 107 and the filter. When transmitting an rf signal, the first switch 112 is closed. This shorts any transmitted signal that may have leaked into the receive signal path to ground. Thus, this closed first switch 112 isolates the remainder of the receiver circuitry including the second ESD protection circuit 106 and input unit 102 during the transmission of an rf signal. Furthermore, by arranging the switch between the node 114 and the filter, the inductor 108 can contribute its impedance during transmission when switch 112 is closed, which may be advantageous.

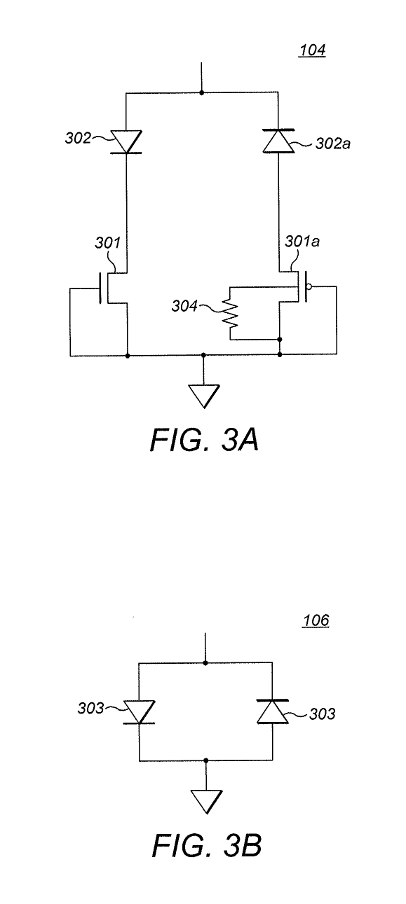

FIG. 3a shows an example circuit for the first protection circuit 104. Preferably, the first protection circuit comprises one or more Grounded Gate MOS transistors (ggMOS). The first protection circuit can comprise a ggNMOS 301 connected in parallel to ggPMOS 301a. The first ESD protection circuit 104 may also comprise a pair of diodes 302 and 302a. Resistor 304, which may be variable may be used to bias ggPMOS 301a to tune the ESD breakdown voltage.

When a positive voltage greater than a triggering voltage (e.g. the second voltage level) occurs at node 105, for example during an ESD event, diode 302 is forward biased and diode 302a is reverse biased. The positive voltage breaks down ggNMOS 301 and conducts to ground. When a negative voltage greater than a triggering voltage (e.g. the second voltage level) occurs at node 105, for example during an ESD event, diode 302 is reverse biased and diode 302a is forward biased. The negative voltage breaks down ggPMOS 301a and conducts from ground. During normal operation of transmitting/receiving an RF signal, for voltage swings above ground, diode 302 is forward biased and diode 302a is reverse biased. The drain of the ggNMOS 301 is reverse biased and does not conduct. During normal operation of transmitting/receiving an RF signal, for voltage swings below ground, diode 302 is reverse biased and diode 302a is forward biased. The drain of the ggPMOS 301 is reverse biased and does not conduct. Thus the first protection circuit 104 does not conduct during normal operation for input signals above or below ground. However, the first protection circuit 104 provides ESD conduction for both positive and negative ESD pulses (above the triggering voltage) and thus protecting the rest of the circuit from an ESD voltage above the trigger voltage.

FIG. 3b shows an example circuit for the second protection circuit 106. The second protection circuit 106 comprises a pair of opposing diodes 303 connected in parallel, each of which being connected to ground. When a voltage above a triggering voltage (e.g. the first voltage level) occurs at node 107, e.g. an ESD signal that has been limited by the first protection circuit 104, the appropriate diode, depending on the polarity of the ESD signal, turns on and creates a current path for the ESD current to ground.

As mentioned above, the second protection circuit 106 may be able to tolerate voltages up to a third voltage level. This may be due to a limitation in the current carrying capability in proportion to the diode periphery of diodes 303. A maximum current carrying capability may be set by the size of the diodes and the process and construction of the diffused junctions of the diodes. Once a maximum current is exceeded, the voltage across a diode can rise rapidly and fail at, for example, a value of a few volts. This limitation can lead to the second protection circuit 106 having a tolerance level.

To provide a second ESD protection circuit 106 that is able to tolerate the voltage at node 107, additional pairs of diodes may be added in series to diodes 303. By adding more diodes in series, the voltage dropped across each diode in series is decreased and thus each diode is less likely to be damaged by the voltage at node 107. However, the addition of more diodes increases the amount of stray capacitance caused by the second protection circuit 106. As mentioned above, providing the inductor 108 between nodes 105 and 107 can help reduce the voltage at node 107. Thus a second protection circuit 106 with a lower tolerance requirement can be provided. This, in turn, reduces the stray capacitance introduced by the second protection circuit 106 as fewer diodes will be required. Requiring fewer diodes also reduces the chip area required for the second protection circuit 106.

Preferably, the second protection circuit 106 does not comprise a ggNMOS transistor. Generally ggNMOS transistors are less effective at protecting components that are susceptible to low voltages and therefore do not provide adequate protection for components that have a low tolerance voltage level. E.g. a ggNMOS transistor may not be suitable to protect the input unit 102 which can be susceptible voltages as low as 0.6V.

During the manufacture of the chip and before it is packaged, the chip pin 101 should be protected against an ESD event. The first and second protection circuits 104 and 106 can protect the input and output units 102 and 110 of an unpackaged chip from an ESD event. Once the chip has been encased in ESD protective packaging, the packaging can act to provide adequate protection from an ESD event. As mentioned above, the protection circuits 104 and 106 can introduce stray capacitances. Thus, as the packaging can provide adequate ESD protection, the first and/or second protection circuits 104 and/or 106 can be fused or disabled so that they do not have any effect on the chip. The protection circuits 104 and/or 106 can be fused after the IC is mounted. Thus the protection circuits 104 and/or 106 can provide protection against ESD strikes until the final mounting of the IC.

The on-chip transmit and receive filtering described herein is suitable for use with radio frequency signals communicated according to any radio frequency protocol. For example, it is suitable for use with radio frequency signals communicated according to Bluetooth protocols.

The examples above describe arrangements in which two elements are coupled. This is intended to mean that those two elements are physically connected. However the two elements are not necessarily directly connected. For example, there may be intermediary elements in between the two elements which are coupled.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. An integrated circuit chip comprising:
a chip pin configured to direct signals on and off chip;
a first signal path from the chip pin to a first electrostatic discharge (ESD) susceptible circuit susceptible to a voltage greater than a first voltage level;
a first protection circuit coupled to a first node on the first signal path, the first protection circuit being operable to limit the voltage of a signal directed on chip to a second voltage level, the second voltage level being higher than the first voltage level; and
a second protection circuit coupled to a second node on the first signal path between the first node and the first ESD susceptible circuit, the second protection circuit being operable to limit the voltage of the signal directed on chip to the first voltage level.

2. An integrated circuit chip as claimed in claim 1, the second protection circuit being susceptible to a voltage greater than a third voltage level, the second voltage level being lower than the third voltage level.

3. An integrated circuit chip as claimed in claim 1, the second protection circuit being susceptible to a voltage greater than a third voltage level, the integrated circuit chip further comprising a passive component coupled between the first node and the second node, the passive component having a resistance so as to limit the voltage of the signal directed on chip to below the third voltage level.

4. An integrated circuit chip as claimed in claim 3, the passive component being configured to, when the integrated circuit chip receives a radio frequency signal, cause that received radio frequency signal to have a higher voltage on input to the first ESD susceptible circuit than when at the chip pin.

5. An integrated circuit chip as claimed in claim 1 further comprising a second ESD susceptible circuit susceptible to a voltage greater than the second voltage level and coupled to a third node on the first signal path between the first node and the second node.

6. An integrated circuit chip as claimed in claim 5, the second ESD susceptible circuit being coupled to the third node so as to provide a second signal path from the chip pin to the second ESD susceptible circuit, the integrated circuit chip further comprising a switch coupling the first signal path between the third node and the first ESD susceptible circuit to ground and operable so as to isolate the first protection circuit from the second signal path.

7. An integrated circuit chip as claimed in claim 5, the first ESD susceptible circuit comprising a low noise amplifier for amplifying received radio frequency signals and the second ESD susceptible circuit comprising a power amplifier for amplifying radio frequency signals for transmission.

8. An integrated circuit chip as claimed in claim 7, the radio frequency signals being in accordance with a Bluetooth protocol.

9. An integrated circuit chip as claimed in claim 1, wherein the first protection circuit comprises a gate grounded transistor and the second protection circuit comprises a diode, and wherein the second protection circuit does not comprise a gate grounded transistor.

10. A method comprising: manufacturing an integrated circuit chip as claimed in claim 1; disabling the first and/or second protection circuit; and packaging the integrated circuit chip.
